(19) United States
(12) Patent Application Publication
(10) Pub. No.: US 2021/0233034 A1
(43) Pub. Date: Jul. 29, 2021

(54) METHOD, APPARATUS, COMPUTER PROGRAM AND COMPUTER RECORDABLE MEDIUM FOR DATABASE CONSTRUCTION

(71) Applicant: BIOCK INC., Seoul (KR)

(72) Inventors: Young Key SHIN, SEOUL (KR); Hae Won LEE, SEOUL (KR); Seon Gyu PARK, SEOUL (KR); Gabe SALGADO, SEOUL (KR)

(21) Appl. No.: 17/227,377

(22) Filed: Apr. 12, 2021

Related U.S. Application Data
(63) Continuation of application No. PCT/KR2019/010911, filed on Aug. 27, 2019.

(30) Foreign Application Priority Data
Oct. 12, 2018 (KR) 10-2018-0121642

(51) Int. Cl. G06Q 10/10; G06F 16/21

(52) U.S. Cl. CPC G06Q 10/1091; G06F 16/21; G06Q 10/101

(57) ABSTRACT

Method, apparatus, and computer recordable medium disclosed herein comprises, receiving a data used for database construction from a user, calculating a time-contribution by inputting time series information regarding order of received data from the user into a function having a higher contribution as the order of receiving time series information is earlier, calculating a data-contribution based on qualitative information or quantitative information included in the data, calculating a construction-contribution that the user contributed to construct database by reflecting the time-contribution to the data-contribution, and applying the construction-contribution to the user's identification information.

### CROSS-REFERENCE TO RELATED APPLICATION

This application is a US Bypass Continuation Application of International Application No. PCT/KR2019/010911, filed on Aug. 27, 2019 and designating the United States, the International Application claiming a priority date of Oct. 12, 2018 based on prior Korean Patent Application No. 10-2018-0121642, filed on Oct. 12, 2018. The disclosure of which is incorporated herein by reference in its entirety.

### BACKGROUND

### 1. Field of the Invention

The present invention relates to a database construction method, an apparatus, and a computer-readable recording medium, and more particularly, to a technology for constructing a database by sharing profits based on the contribution of users who participated in the construction of the database.

### 2. Discussion of Related Art

Recently, as big data is essential in various fields such as artificial intelligence, machine learning, genetic analysis, disease prediction, and future prediction, the value of individual information is increasing day by day.

In addition, due to the development of the Internet platform industry, many people use platforms such as Amazon, Facebook, YouTube, and Twitter to upload data containing personal information to the Internet or left as a log of the search history such as search history, purchase history.

These data are generally stored in the database of the platform service provider, and the platform service provider manages the information. Profits are generated when the platform service provider creates other services by using the data including personal information or sells the data to a third party. However, the problem of unfairness has been raised because profits using individual data used in database construction are returned only to the subject of platform services.

In addition, when the platform service provider uses or sells the database without consent to the use of personal information, a problem of infringement of personal information occurs, which can be problem. Accordingly, the necessity of acknowledging the ownership of the database to each individual is required with the consent of the individual regarding the use of the database constructed by collection of individual information.

### PRIOR ART

(Prior Arts 0001) KR patent publication number 10-2018-0081470: system for hiding information using lightweight mutual authentication based on biometric in mobile environment, method thereof and computer recordable medium storing program to perform the method.

### SUMMARY OF THE INVENTION

At least one example embodiment provides a biometric information database construction method performed by a database construction device comprising: Receiving a data used for database construction from a user; calculating a time-contribution by inputting time series information regarding order of received data from the user into a function having a higher contribution as the order of receiving time series information is earlier; calculating a data-contribution based on qualitative information or quantitative information included in the data; calculating a construction-contribution that the user contributed to construct database by reflecting the time-contribution to the data-contribution; and applying the construction-contribution to the user's identification information.

According to an aspect, the step of calculating time-contribution in the method may comprises, calculating the time-contribution by inputting the time-series information to at least one of an-nth order (n is a natural number of 1 or more) function that decreases as time increases, a step function, a log function, and an exponential function.

According to an aspect, the step of calculating the data-contribution in the method comprises, calculating the data-contribution by summing contribution points predetermined for each type of information included in the data.

According to an aspect, the step of calculating the data-contribution in the method comprises, calculating the data-contribution by applying weight to the summed contribution points according to the number of types of information included in the data.

According to an aspect, the step of calculating the data-contribution in the method comprises, calculating the data-contribution by applying weight predetermined to the plurality of information, when a plurality of types of information included in the data corresponding to a plurality of types of information in the device.

According to an aspect, the step of calculating construction-contribution in the method comprises, calculating the construction-contribution, in case that at least one part of the contents of information included in the data comprises the predetermined contents of information, by applying weight inversely proportional to the number of users who possess the predetermined contents of information based on a number of users possess the predetermined contents of information regarding all users who participate in the construction of database.

According to an aspect, the step of calculating construction-contribution in the method comprises, calculating the construction-contribution by summing the time-contribution and the data-contribution when a first data and a second data among the data are received at different times, wherein the time-contribution is calculated based on time series information of each od the first data and the second data, wherein the data-contribution calculated based from each of the first data and the second data.

According to an aspect, the step of applying construction-contribution in the method comprises, connecting a block generated into a blockchain, wherein the block comprises at least one of, the construction-contribution information, the time series information, the user's identification information, wherein the blockchain is connected other user's blocks who participate in construction of the database. According to an aspect, the method further comprises, calculating an equity of the user regarding the database as the user's construction contribution regarding summation of other users' construction-contribution who participated in construction of the database.

According to an aspect, the method further comprises, sharing the profit according to the equity to the user.

According to an aspect, the step of sharing in the method further comprises, sharing predetermined ratio of profit to some users according to the some users' equity, when profit is generated by biometric data of some users among the biometric data of all users included in the database.

According to an aspect, the step of sharing in the method further comprises, sharing predetermined ratio of profit to some users according to the some users' equity, when profit is generated by biometric data of some users among the biometric data of all users included in the database.

At least one example embodiment provides, A database construction device, comprises: A receiving module receives data used in database construction from a user; A contribution calculating module calculates a time-contribution that has a higher contribution as the order of receiving time series information is earlier, by inputting time series information regarding order of received data from the user into a function having a higher contribution as the order of receiving time series information is earlier, calculates a data-contribution based on qualitative information or quantitative information included in the data, calculates a construction-contribution that the user contributed to construct database by reflecting the time-contribution to the data-contribution.

At least one example embodiment provides a computer-readable recording medium on which a computer program including instructions for implementing a processor to perform the method provided above is recorded.

According to an embodiment of the present invention, by calculating the user's contribution based on the time series information that the user uploaded his/her data to the server, the quantitative information of the data, and the qualitative information of the data, the contribution to the database construction of each user It can be calculated objectively, and by inducing data uploads in the beginning, it is possible to construct a database of data of good quality, both qualitatively and quantitatively, and quickly.

Through this, by sharing the equity of the database according to the user's contribution, users can receive the profits generated from the use of the database where their information is gathered and built.

### BRIEF DESCRIPTION OF THE DRAWINGS

Example embodiments will be described in more detail with regard to the figures, wherein like reference numerals refer to like parts throughout the various figures unless otherwise specified, and wherein:

FIG. 1 is a diagram showing a system for implementing a database construction method according to an embodiment of the present invention.

FIG. 2 is a flowchart showing a comprehensive process of a database construction method according to an embodiment of the present invention.

FIG. 3 is a flow chart illustrating a process of calculating a contribution in a database construction method according to an embodiment of the present invention.

FIG. 4A, 4B, 4C, 4D is an exemplary diagram of a function for calculating time-contribution according to an embodiment of the present invention.

FIG. 5A is an exemplary diagram for explaining a method of calculating data-contribution according to an embodiment of the present invention.

FIG. 5B is an exemplary diagram for explaining a method of assigning weights according to the rarity of data contents according to an embodiment of the present invention.

FIG. 6A is an exemplary diagram for explaining the construction-contribution of a user according to a data upload order as an embodiment of the present invention.

FIG. 6B is an exemplary diagram for explaining the distribution of users for construction-contribution as an embodiment of the present invention.

FIG. 7 is a configuration diagram of a database construction device according to an embodiment of the present invention.

### DETAILED DESCRIPTION OF EXEMPLARY EMBODIMENTS

Hereinafter, advantages and features of the present invention, and a method of achieving them will become apparent with reference to the embodiments described below in detail together with the accompanied drawings. For simplicity of description and general understanding of the disclosure, like reference numerals refer to like components throughout the present specification although they are illustrated in different drawings. The example embodiments, however, may be embodied in various forms, and should not be construed as being limited to only the specific example embodiments. Rather, the example embodiments should be understood to include all the modifications, equivalents, and substitutions included in the spirit and technical scope of the disclosure.

In describing the embodiments of the present invention, detailed descriptions of known functions or configurations will be omitted except when necessary in describing the embodiments of the present invention. Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

The functional blocks shown in the drawings and described below are only examples of possible implementations. In other implementations, other functional blocks may be used without departing from the scope of the detailed description. Also, although one or more functional blocks of the present invention are represented as individual blocks, one or more of the functional blocks of the present invention may be a combination of various hardware and software configurations that perform the same function.

In addition, the expression that includes certain elements is an open expression, merely refers to the existence of the corresponding elements, and should not be understood as excluding additional elements.

Furthermore, when a component is connected to or is referred to as being connected to another component, it should be understood that it may be directly connected or connected to the other component, but other components may exist in the middle.

Although the terms “first,” “second,” etc., may be used herein to describe various components, the components should not be limited by these terms. These terms are only used to distinguish one component from another component. For example, a first component may also be termed a second component and, likewise, a second component may be termed a first component, without departing from the scope of this disclosure. As used herein, the term “and/or” includes any and all combinations of one or more of the associated items.

Hereinafter, embodiments of the present invention will be described with reference to the drawings.

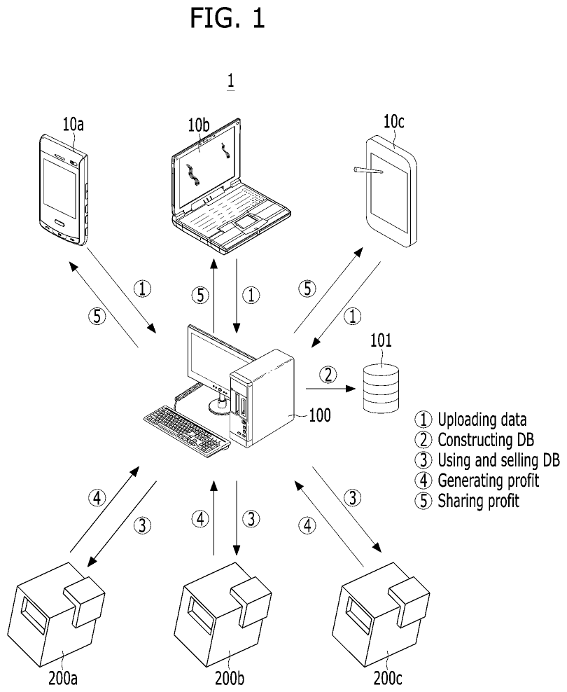

FIG. 1 illustrates an exemplary embodiment of present invention of a system 1 performing a database construction method.

Referring to FIG. 1, the system 1 for implementing the database construction method according to an embodiment of the present invention comprises user terminals 10a, 10b, and 10c, a database construction device 100, and a database using devices 200a, 200b, and 200c.

The user terminal 10 transmits data including user information to the database construction device 100. In this case, the data may comprise information corresponding to the purpose of the database 101.

For example, if the database 101 is a database 101 to be constructed based on biometric information, the database 101 may comprise user's disease information, tissue image information, clinical trial information, genetic information, pathology information, and such.

In addition, if the database 101 is a database 101 to be constructed based on financial information, the database 101 may comprise user asset information, credit rating information, annual salary information, and such.

In addition, if the database 101 is a database 101 to be constructed based on a purchase history, the database 101 may comprise age information, residence area information, access time information, payment information of the user and such.

As such, data that can be used according to an embodiment of the present invention may comprise various types of information according to the purpose of the database 101, and the type of data to be used is not limited to the above-described examples.

However, in the description of the present specification, for convenience of understanding, it is assumed that the database 101 based on biometric information is constructed, and the data transmitted from the user terminal 10 is assumed to be biometric data.

The database construction device 100 receives biometric data from the user terminal 10. Accordingly, the database construction device 100 calculates the user's contribution to the construction of the database 101 according to the time series information, quantitative information, or qualitative information included in the received biometric data. The database construction device 100 may give a user equity for the value of the database 101 based on this contribution. Thereafter, the database construction device 100 may share the generated profit to users based on equity when profit occurs due to the database 101 being utilized.

The database using device 200 may use the database 101 generated by the database construction device 100.

At this time, as described above, if the generated database 101 is a database 101 constructed based on the user's biometric information, the database using device 200 can be used to predict disease according to the genes of the people by utilizing the database 101.

In addition, if the generated database 101 is a database 101 constructed based on the user's financial information, the database using device 200 can use the database 100 to construct a process for predicting an appropriate financial product according to the user's asset level.

In addition, if the database 101 is a database 101 constructed based on the user's purchase history, the database 101 can be used to construct a process for automatically recommending an appropriate goods according to the user's purchase history.

To this end, the database using device 200 may provide an appropriate price for the use of the database 101 or purchase to the database construction device 100. For this profit, the database construction device 100 may share the generated profit to users based on equity when the database 101 is utilized and the profit occurs.

At this time, the user terminal 10, the database construction device 100, and the database using device 200 may transmit and receive information through a wired or wireless network.

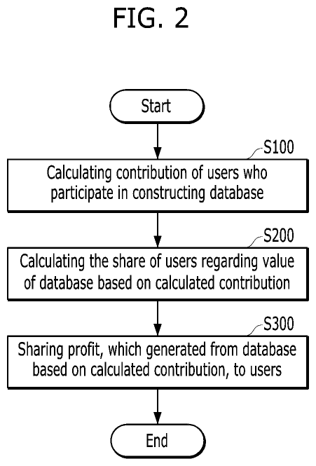

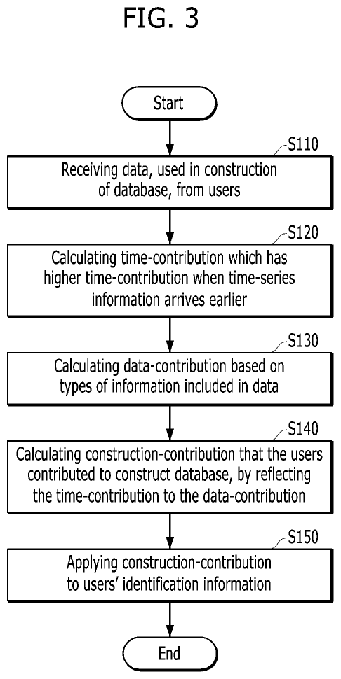

In order to describe in more detail the database construction method for actualizing the system 1 for implementing the database construction method according to an embodiment of the present invention, the implementation steps of the database construction method will be comprehensively described with reference to FIG. 2, and further each step will be described in detail together with FIGS. 3 to 6.

FIG. 2 is a flowchart illustrating a comprehensive process of a database construction method according to an embodiment of the present invention. Each step of the database construction method according to FIG. 2 may be performed by the database construction device 100, and each step performed by the database construction device 100 will be described as follows.

First, in operation S100, the database construction device 100 may receive biometric data from the user and calculate the contribution of the user who participated in the construction of the database 101.

Thereafter, in operation S200, the database construction device 100 may calculate the user's equity for the value of the database 101 based on the calculated contribution.

Accordingly, in operation S300, when a profit is generated by the database 101, the database construction device 100 may allocate the generated profit to users based on the calculated equity.

FIG. 3 is a flow chart showing a process of calculating a contribution among a database construction method according to an embodiment of the present invention. In the following description, for convenience of understanding, the construction of the biometric information-based database 101 will be described as an example. Each step of the database construction method according to FIG. 3 may be performed by the database construction device 100. Here, the order of each step does not limit the order of time-series of the method, and may be performed by changing the order of each step according to the choice of a person skilled in the art. Thus, each step will be described as follows.

First, in operation S110, the database construction device 100 may receive biometric data to be used for constructing the database 101 from the user. The database construction device 100 may directly receive biometric data from the user terminal 10 based on transmission through a communication network or may collect and receive log records left by the user terminal 10 on the Internet.

In this case, the biometric data may include information on a plurality of items. For example, biometric data may include genomic information, genetic information, tissue image information, clinical information, or pathology information, but is not limited to these examples.

Second, in operation S120, the database construction device 100 may calculate a time-contribution having a higher contribution as the order of time-series received from the user increases based on the time series information included in the biometric data (S120). In other words, as the time when a user uploads biometric data is earlier than other users, a higher contribution is given to the database 101 construction.

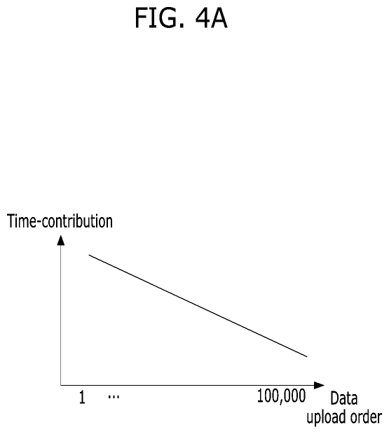

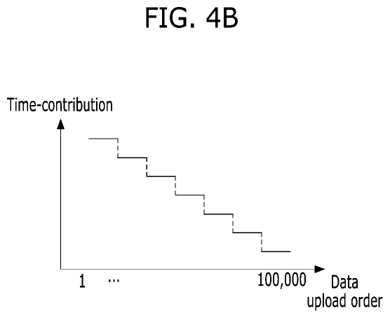

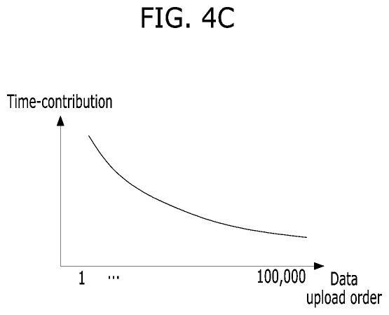

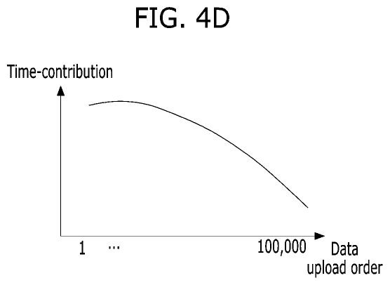

At this time, the time series information may be determined based on the order or time in which the user uploaded biometric data, or the order or time in which the user left biometric data in the Internet log, but is not limited to this example. More specifically, the database construction device 100 may use the means of FIG. 4.

FIG. 4A, 4B, 4C, 4D is an exemplary diagram of a function for calculating time-contribution according to an embodiment of the present invention.

Referring to FIG. 4, the database construction device 100 can calculate the time-contribution by inputting biometric data's time series information, wherein biometric data is received at least one of an-nth order (n is a natural number of 1 or more) function that decreases as time increases (FIG. 4A), a step function (FIG. 4B), a log function (FIG. 4C), and an exponential function (FIG. 4D).

For example, if the user uploads the same data at different times, then the user's time-contribution can be calculated by designing a function so that the contribution of the first uploaded user and the 100,000th uploaded user is about 10 times different.

Accordingly, as the user can be given a higher time-contribution as the time or order of uploading biometric data to the database construction device 100 is earlier, the database 101 can be quickly established by inducing users to upload data faster.

Third, in operation S130, the database construction device 100 may calculate data-contribution based on qualitative information or quantitative information that included in biometric data.

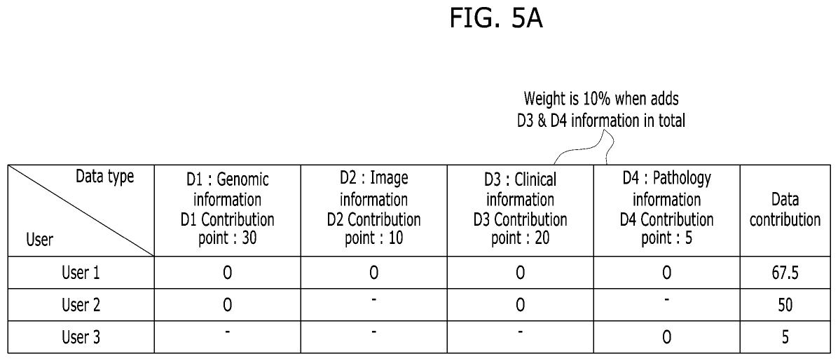

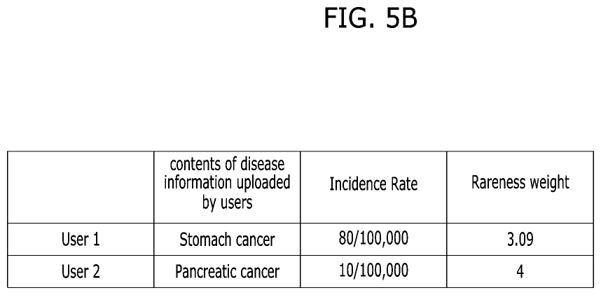

FIG. 5A is an exemplary diagram illustrating a method of calculating data-contribution according to an embodiment of the present invention.

Referring to FIG. 5A, the database construction device 100 may calculate data-contribution by summing up a predetermined contribution point for each type of information included in biometric data. For example, as shown in FIG. 5A, if information corresponding to D1 and D3 is included in the biometric data of user 2, the contribution points set in D1 and D3 are summed, and data-contribution can be calculated like 30+0+20+0=50.

In this case, the data-contribution can be calculated by adding a predetermined weight to a plurality of parts of information, when the predetermined plurality of parts of information as providing added value to each other in data analysis are included among the parts of information included in the data. For example, it is assumed that clinical information and pathology information are information that adds value to each other, and if such information is included together, a 10% weight is added to the biometric data to calculate the data-contribution. If so, as shown in FIG. 5A, since information corresponding to D1 to D4 is included in the biometric data of user 1, the contribution points predetermined to D1 to D4 are added, but a 10% weight is added to the sum 25 of the points corresponding to D3 and D4, and thus the data-contribution will be calculated as 30 +10+(20+5)*1.1=67.5.

In addition, data-contribution can be calculated by adding weight to the summed value according to the number of types of information included in the data.

For example, if more than 4 types of biometric data are included, it is assumed that a weight of 3.8% is added. If so, since 4 types of information corresponding to D1 to D4 are included in the biometric data of user 1 shown in FIG. 5A, a predetermined value is added to D1 to D4, but a weight of 3.8% is added, and thus the data-contribution will be calculated as (30+10+20+5)*1.038=67.5.

In addition, the data-contribution can be calculated by adding a weight which is inversely proportional to the number of users who have the predetermined information, based on the number of users who have predetermined information regarding all users who participated in the construction of the database 101. More specifically, this embodiment will be described with reference to FIG. 5B.

FIG. 5B is an exemplary diagram for explaining a method of applying weights according to the rarity of data content according to an embodiment of the present invention.

Referring to FIG. 5B, application of higher weight when a content of information included in disease information that included in biometric data is stomach cancer or pancreatic cancer is assumed, to apply higher contribution to a user contains rare information, when information included in biometric data is very rare to other users.

In this case, the added weight can be designed to receive a higher weight as the information is more rare, by using a calculation method of −log function (incidence rate). At this time, the incidence rate may be calculated by using certified disease probability statistics data, or by aggregate statistics of information stored in the database 101 being constructed, but the incidence rate is not limited to this example.

Accordingly, as shown in FIG. 5B, since user 1 includes information on ‘gastric cancer’ among disease information, a rarity weight corresponding to −log [symbol] (80/100,000)=3.09 can be calculated, and since user 2 includes information on ‘pancreatic cancer’ among disease information, the rarity weight corresponding to −log [symbol] (10/100,000)=4 can be calculated.

The rarity weight calculated in this way may be separately added to the data-contribution and reflected or reflected in a multiplying method, or the rarity weight may be used in the step of calculating the construction-contribution to be described later. However, it is not limited to this example and the rarity weight can be reflected in the user's contribution in various ways.

The rarity weight calculated in way described above may be separately reflected to the data-contribution as summation or multiplication, or the rarity weight may be used in a step of calculating a construction-contribution described later. However, it is not limited to this example and the rarity weight can be reflected in the user's contribution in various ways.

Meanwhile, each of the embodiments that can be applied to calculate the data-contribution may be combined according to the selection of the administrator who uses the database construction device 100 to calculate the data-contribution. Thereafter, in operation S140, the database construction device 100 may calculate a construction-contribution, which means the degree to which the user finally contributed to the construction of the database 101 by reflecting the calculated time-contribution to the calculated data-contribution.

For example, the database construction device 100 calculates a construction-contribution by inputting the data-contribution into a function designed to calculate a time-contribution having a higher contribution as the time series information arrives earlier or calculates the construction-contribution by multiplying pre-calculated data-contribution and time-contribution. However, the method of calculating the construction-contribution is not limited to this example.

Meanwhile, when a user divides and uploads biometric data multiple times, the database construction device 100 may separately calculate and add the construction-contribution of each biometric data according to the time series information included in each biometric data.

For example, when the same user uploads a plurality of biometric data at different times, biometric data received at time t1 is referred to as first data, and biometric data received at time t2 is referred to as second data.

In this case, the database construction device 100 may calculate a first time-contribution and a second time-contribution calculated based on the time series information t1 and t2 of the first data and the second data, respectively. In addition, the database construction device 100 may calculate a first data-contribution and a second data-contribution by separately calculating data-contribution from each of the first data and the second data.

Accordingly, the database construction device 100 may calculates a final contribution reflecting each upload time or order even if a user uploaded biometric data multiple times, in a way of calculating the first construction-contribution based on the first time-contribution and the first data-contribution, calculating the second construction-contribution based on the second time-contribution and the second data-contribution, and summing the first construction-contribution and the second construction-contribution.

In addition, in operation S150, the database construction apparatus 100 may applying calculated construction-contribution to the user's identification information. For example, the database construction device 100 can manage transparently by assigning the calculated construction-contribution to the user's identification information by recording on blockchain or can manage through a storage device or server by mapping calculated construction-contribution to user's identification information.

As an example, the database construction device 100 may generate a block including information obtained based on the user's biometric data, connect it to blocks of other users who participated in the construction of the database 101 and store it on the blockchain.

For example, when the database construction device 100 receives biometric data from a new user, the user's public key corresponding to the identification information (or address), information included in the biometric data (time series information, Blocks containing qualitative information or quantitative information), time-contribution, data-contribution, construction-contribution, or equity can be generated and linked to blocks containing previous user information.

Meanwhile, the information to be recorded in the block may be information including user identification information and biometric data, but it may be designed to separate information to be recorded on the blockchain and information to be stored in the server according to the administrator's selection.

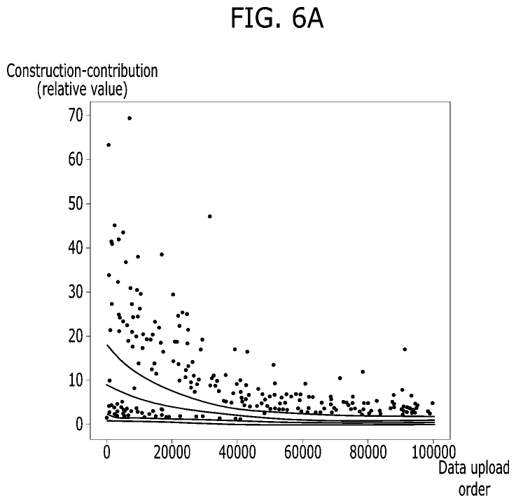

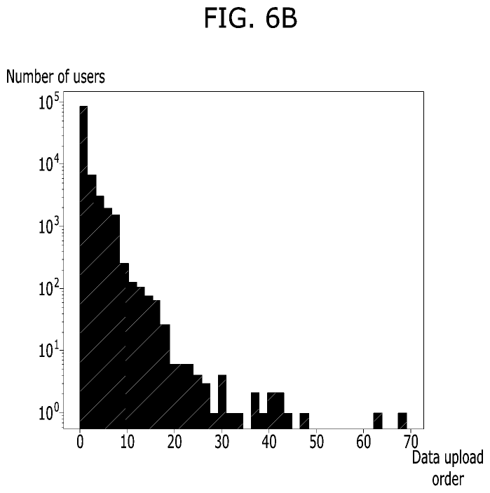

FIG. 6 6 is a result of a simulation by applying an embodiment of the present invention to the statistics of the probability of cancer incidence according to the “major statistics of cancer incidence rate” of the public data portal. In this case, FIG. 6A is an exemplary diagram for explaining the construction-contribution of a user according to the data upload order as a simulation result according to an embodiment of the present invention, and FIG. 6B is an example diagram for explaining the distribution of users as a simulation result according to an embodiment of the present invention.

In this simulation, the biometric data to be used as a sample was generated to include any one or more of information the types of information in the biometric data, that includes D1-disease type information (contents: information about cancer according to “cancer incidence rate key statistics”), D2-pathology information (contents: yes/no) and D3-clinical (contents: yes/no).

At this time, to assume that 100,000 users upload biometric data, but only disease information (D1) is fully uploaded, and pathology information (D2) and clinical information (D3) are only uploaded by some users, the probability of including information (D1) was set to 100%, the probability of including D2 was set to 30%, and the probability of including D3 was set to 10%.

On the other hand, the relative contribution point of D1:D2:D3 was set to 5:45:5, and in this case, if all of D1, D2, and D3 were included, the contribution point was set to be ‘100’ by putting weights. Therefore, data-contribution calculated according to the type or number of information included in biometric data is as follows.

Including D1: 5

Including D1, D2: 50

Including D1, D3: 10

Including D1, D2, D3: 100

After that, the time-contribution calculation method was designed so that the contribution of the 1st uploader has about 10 times than the contribution of the 100,000th uploader as the contribution decreased in the form of an exponential function according to the order in which the biometric data was uploaded.

In addition, when referring to “Key statistics of cancer incidence rate”, the actual probability of developing pancreatic cancer is about 10/10,0000, so in the simulation, sample biometric data is created to has 10 out of 100,000 people to diagnosed as “pancreatic cancer” patients.

Accordingly, if the content of disease information among biometric data has “pancreatic cancer”, a rarity weight of −log [symbol] (10/100,000)=4 is applied to yield the final construction-contribution by multiplying the pre-calculated construction-contribution from time-contribution and data-contribution.

Through this, the average of the finally calculated construction-contribution was adjusted to be ‘1’, and the final contribution was expressed in a range of 1 to 70 as adjusts so that the average of the construction-contribution goes to “1”.

Accordingly, referring to FIG. 6A, the construction-contribution decreases according to the data upload order as a whole, and construction-contribution shows a difference even within a similar order according to data-contribution. In addition, referring to FIG. 6B, it can be seen that in most cases, the number of users having a high contribution decreases in the form of a negative exponential function while having a contribution between 0 and 1.

Accordingly, through FIGS. 6a and 6b, while giving high construction-contribution to the user who uploaded first and the user who uploaded high-quality data, it can be implemented to realize the object of the invention that allows many people to participate by not driving only one user have the whole contribution.

Thereafter, in operation S200, the database construction device 100 calculates each user's equity based on the user's construction-contribution regarding a summation of construction-contribution given to other users who participated in the construction of the database 101, in operation of calculating the equity of the user regarding value of the database 101 based on the calculated contribution.

For example, if the total number of users is n, and the contribution of user x is Cx, then user x's equity=a*(Cx/sum(C1,C2, . . . , Cn))*100 (%) can be defined.

Here, “a” is the equity ratio of all users to the total equity of the database 101, and if the ownership equity of users for the entire database 101 is set to 50%, “a” may be 0.5. Thus, “a” can be a value between 0 and 1.

Accordingly, when a=1, if user 1's contribution is 30, the initial equity that user 1 has is 1*(30/30)*100=100%, and if a new user 2's contribution of 20 occurs, user 1 The equity of user 2 can be 1*(30/(30+20))*100=60%, and the equity of user 2 can be 1*(20/(30+20))*100=40%.

Thereafter, as a new user participates in constructing the database 101, the ratio of users may be newly updated according to the above process.

In addition, in operation S300, when profit is generated by the database 101, the database construction device 100 shares the generated profit to users based on the calculated equity, wherein amount of sharing is proportional to ‘equity’.

In addition, if profit is generated due to biometric data of some users in the established database 101, a predetermined percentage of the generated profit is further shared to some users according to the equity of some users, and thus profit can be shared at a larger percentage because of some users' equity.

For example, if a data purchasing institution purchased one thousand data out of the total data of 100,000 people included in the database 101, 40% of the total profit is distributed according to the equity of 100,000 people, and 60% of the total profit is It can be distributed according to the relative equity ratio within 1000 people to each 1000 people who are the owners of biometric data.

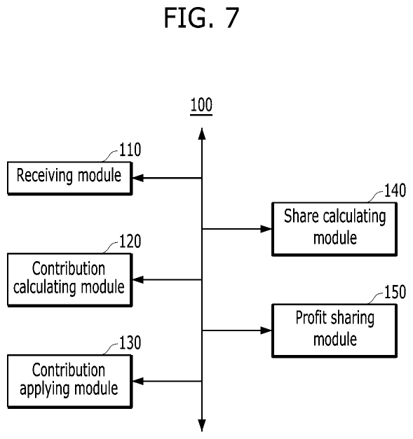

FIG. 7 is a configuration diagram of a database construction device 100 according to an embodiment of the present invention.

FIG. 7 depicts a database construction device 100 according to an embodiment of the present invention, that comprises a receiving module 110, a contribution calculating module 120, a contribution applying module 130, a share calculating module 140, and a profit sharing module 150.

The receiving module 110 may receive biometric data used to construct the database 101 from a user.

The contribution calculating module 120 may calculate a time-contribution having a higher contribution as the time series information reaches, based on the time series information included in the biometric data and may calculate data-contribution based on qualitative or quantitative information included in biometric data.

The contribution applying module 130 may apply construction-contribution to the user's identification information.

The share calculating module 140 may calculate the user's equity for the value of the database 101 based on the calculated construction-contribution.

The profit sharing module 150 may distribute profits generated from the database 101 to users based on the calculated equity.

Meanwhile, a process for performing the corresponding operation of the components included in the database construction device 100 according to the above-described embodiment has been described with reference to FIGS. 2 to 6, and thus a duplicate description will be omitted.

Meanwhile, the receiving module 110, the contribution calculating module 120, the contribution applying module 130, the share calculating module 140, and the profit sharing module 150 may be implemented by a memory including instructions programmed to perform these functions, and a computing device including a microprocessor that executes these instructions.

According to the above-described embodiment, the degree of contribution to the construction of the user's database 101 is calculated based on the time series information, the quantitative information of the data, and the qualitative information of the data in which the user uploads his/her data to the server. And accordingly, each user's contribution to the database 101 construction can be objectively calculated. The present invention induces data uploading at an early stage, so that it is possible to construct a database quickly, qualitatively, and quantitatively 101 of good quality data.

Through this, by distributing the equity of the database 101 according to the user's contribution, users can receive a reasonable return on profits generated in the utilization of the database 101 that is built by collecting their information.

The above-described embodiments of the present invention can be implemented through various means. For example, embodiments of the present invention may be implemented by hardware, firmware, software, or a combination thereof.

In the case of hardware implementation, the method according to embodiments of the present invention includes one or more Application Specific Integrated Circuits (ASICs), Digital Signal Processors (DSPs), Digital Signal Processing Devices (DSPDs), and Programmable Logic Devices (PLDs). Field Programmable Gate Arrays (FPGAs), processors, controllers, microcontrollers, microprocessors, and the like.

In the case of implementation by firmware or software, the method according to the embodiments of the present invention may be implemented in the form of a module, procedure, or function that performs the functions or operations described above. A computer program in which a software code or the like is recorded may be stored in a computer-readable recording medium or a memory unit and driven by a processor. The memory unit may be located inside or outside the processor, and may exchange data with the processor through various known means.

Further, combinations of each block of the block diagram attached to the present invention and each step of the flow chart may be performed by computer program instructions. These computer program instructions may be mounted on the encoding processor of a general-purpose computer, special purpose computer, or other programmable data processing equipment, so that the instructions executed by the encoding processor of the computer or other programmable data processing equipment are each block of the block diagram or It creates a means to perform the functions described in each step of the flow chart.

It is also possible for these computer program instructions to be stored in a computer usable or computer readable memory that can be directed to a computer or other programmable data processing equipment to implement a function in a particular way. Accordingly, it is also possible to produce an article of manufacture containing instruction means for performing the functions described in each block of a block diagram or each step of a flow chart with instructions stored in the computer-usable or computer-readable memory.

Computer program instructions may be mounted on a computer or other programmable data processing equipment. Thus, a series of operational steps can be performed on a computer or other programmable data processing equipment to create a computer-executed process. It is also possible for instructions to perform a computer or other programmable data processing equipment to provide steps for executing the functions described in each block in the block diagram and in each step in the flow chart.

In addition, each block or step may represent a module, segment, or part of code that contains one or more executable instructions for executing a specified logical function. It should also be noted that in some alternative embodiments, functions mentioned in blocks or steps may occur out of order. For example, two blocks or steps shown in succession may in fact be performed substantially simultaneously, or the blocks or steps may sometimes be performed in the reverse order depending on the corresponding function.

As such, those skilled in the art to which the present invention pertains will be able to understand that the present invention can be implemented in other specific forms without changing the technical spirit or essential features thereof. Therefore, the embodiments described above are illustrative in all respects and should be understood as non-limiting. The scope of the present invention is indicated by the claims to be described later rather than the detailed description, and all changes or modified forms derived from the meaning and scope of the claims and their equivalent concepts should be interpreted as being included in the scope of the present invention.

What is claimed is:

1. A biometric information database construction method performed by a database construction device comprising:
receiving a data used for database construction from a user;
calculating a time-contribution by inputting time series information regarding order of received data from the user into a function having a higher contribution as the order of receiving time series information is earlier;
calculating a data-contribution based on qualitative information or quantitative information included in the data;
calculating a construction-contribution that the user contributed to construct database by reflecting the time-contribution to the data-contribution; and
applying the construction-contribution to the user's identification information.

2. The method of claim 1, wherein the step of calculating time-contribution comprises,
calculating the time-contribution by inputting the time-series information to at least one of an-nth order (n is a natural number of 1 or more) function that decreases as time increases, a step function, a log function, and an exponential function.

3. The method of claim 1, wherein the step of calculating the data-contribution comprises,
calculating the data-contribution by summing contribution points predetermined for each type of information included in the data.

4. The method of claim 3, wherein the step of calculating the data-contribution comprises,
calculating the data-contribution by applying weight to the summed contribution points according to the number of types of information included in the data.

5. The method of claim 3, where in the step of calculating the data-contribution comprises,
calculating the data-contribution by applying weight predetermined to the plurality of information, when a plurality of types of information included in the data corresponding to a plurality of types of information in the device.

6. The method of claim 1, the step of calculating construction-contribution comprises,
calculating the construction-contribution, in case that at least one part of the contents of information included in the data comprises the predetermined contents of information, by applying weight inversely proportional to the number of users who possess the predetermined contents of information based on a number of users possess the predetermined contents of information regarding all users who participate in the construction of database.

7. The method of claim 1, the step of calculating construction-contribution comprises,
calculating the construction-contribution by summing the time-contribution and the data-contribution when a first data and a second data among the data are received at different times,
wherein the time-contribution is calculated based on time series information of each od the first data and the second data,
wherein the data-contribution calculated based from each of the first data and the second data.

8. The method of claim 1, the step of applying construction-contribution comprises,
connecting a block generated into a blockchain,
wherein the block comprises at least one of, the construction-contribution information, the time series information, the user's identification information,
wherein the blockchain is connected other user's blocks who participate in construction of the database.

9. The method of claim 1, further comprising:
calculating a equity of the user regarding the database as the user's construction contribution regarding summation of other users' construction-contribution who participated in construction of the database.

10. The method of claim 9, further comprising:
sharing the profit according to the equity to the user.

11. The method of claim 10, wherein, the step of sharing further comprises,
sharing predetermined ratio of profit to some users according to the some users' equity, when profit is generated by biometric data of some users among the biometric data of all users included in the database.

12. A database construction device, comprises:
a receiving module receives data used in database construction from a user;
a contribution calculating module calculates a time-contribution that has a higher contribution as the order of receiving time series information is earlier, by inputting time series information regarding order of received data from the user into a function having a higher contribution as the order of receiving time series information is earlier, calculates a data-contribution based on qualitative information or quantitative information included in the data, calculates a construction-contribution that the user contributed to construct database by reflecting the time-contribution to the data-contribution.

13. A computer-readable recording medium on which a computer program including instructions for implementing a processor to perform the method of claim 1 is recorded.
